(19) United States
(12) Patent Application Publication
(10) Pub. No.: US 2024/0021899 A1
(43) Pub. Date: Jan. 18, 2024

(54) METHOD OF RECYCLING DRY ELECTRODE FILM

(71) Applicants: Hyundai Motor Company, Seoul (KR); Kia Corporation, Seoul (KR)

(72) Inventors: Yong Il Cho, Seoul (KR); Han Nah Song, Ansan (KR); Hyun Jin Kim, Daegu (KR)

(21) Appl. No.: 18/081,420

(22) Filed: Dec. 14, 2022

(30) Foreign Application Priority Data
Jul. 18, 2022 (KR) 10-2022-0088103

(51) Int. Cl. H01M 10/54; H01M 4/04; H01M 4/62

(52) U.S. Cl. CPC H01M 10/54; H01M 4/0435; H01M 4/623; H01M 2004/021

(57) ABSTRACT

Provided is a method for recycling a dry electrode film. More specifically, provided is a method for recycling a dry electrode film that can produce a dry electrode film of the same quality as a dry electrode film using a new raw material using recycled waste material by introducing a separate treatment step for the waste electrode generated during the production of the dry electrode film. The method for recycling a dry electrode film includes: obtaining waste materials to be recycled by crushing a waste electrode; collecting recycled materials that satisfy a preset powder flow index among the recycled waste materials above; and preparing an electrode material including the recycled material and manufacturing an electrode film using the electrode material.

The present application claims under 35 U.S.C. § 119(a) the benefit of Korean Patent Application No. 10-2022-0088103, filed Jul. 18, 2022, the entire contents of which is incorporated herein for all purposes by this reference.

### BACKGROUND

### Technical Field

The present disclosure relates to a method for recycling a dry electrode film. More specifically, the present disclosure relates to a dry electrode film recycling method that capable of producing a recycled dry electrode film with the same quality as a dry electrode film made from raw materials by introducing a separate treatment step for processing waste electrodes generated during the production of dry electrode films.

### Background

A conventional electrode manufacturing method using a dry process is known as a technique for making an electrode film by mixing an electrode active material, a binder, and a conductive material to prepare a powder mixture without using a liquid medium such as a solvent or a dispersion medium, and then passing the powder mixture through a pressing roll.

This dry process for electrode film manufacturing is spotlighted in terms of effectively increasing energy density and reducing investment costs compared to the existing wet process, but there is still room for improvement.

On the other hand, waste electrodes generated due to defective materials and process failures during the fabrication of dry electrode films can be recovered and reused, it will be very desirable in terms of industry-economic and environmental aspects.

Conventionally, when recycling waste electrodes, the waste electrodes were introduced to the existing system without considering changes in material properties. This posed a problem that recycled materials (recovered waste materials) and new raw materials (fresh raw materials) are not well mixed, and it was difficult to obtain the same quality products as products made from only fresh raw materials.

Therefore, under the background described above, it is necessary to develop a method for effectively recycling waste electrodes generated during the fabrication of dry electrode films.

### SUMMARY

An objective of the present disclosure is to provide a method for recycling a dry electrode film so as to effectively recycle a waste electrode generated during fabrication of dry electrode films.

The objective of the present disclosure is not limited to the objective mentioned above. The objectives of the present disclosure will become more apparent from the following description and will be realized by means and combinations thereof described in the claims.

A method for recycling a dry electrode film, according to the present disclosure, includes: obtaining waste materials to be recycled by crushing waste electrodes; collecting a recycling material that satisfy a preset powder flow index among the waste materials; and preparing an electrode material including the collected recycling material and manufacturing an electrode film using the electrode material.

In the method, before the obtaining of the waste materials, calendering or pressing a new material to form a sheet, and slitting a periphery portion the sheet to produce an electrode film and a waste electrode may be further performed.

The new material may include an electrode active material, a conductive material, and a binder. The binder may be a fibrous binder.

The binder may be selected from those including polytetrafluoroethylene (PTFE), which are essentially made of polytetrafluoroethylene (PTFE), or that polytetrafluoroethylene (PTFE) is not necessarily used.

The electrode active material, the conductive material, and the binder may be mixed without a liquid medium or a dispersion medium.

The obtaining of waste materials may be performed by using at least one selected from the group consisting of a roll mill, a ball mill, a jet mill, a planetary mill, and an attrition mill.

In the obtaining of waste materials, the waste electrode may be pulverized for a duration equal to or shorter than 40 minutes, preferably 10 to 40 minutes, at a speed in a range of 1,000 to 6,000 rpm.

The powder flow index may be measured under a condition in which an external force is in a range of 0 to 15 kPa according to the analysis method of ASTM D6128.

The preset powder flow index may be in a range of “A±0.02” when the powder flow index value of the new material is “A”.

When the preset powder flow index is not satisfied, the recycling material may be pulverized, subjected to measurement of a powder flow index, and collected.

The preparing of an electrode film using the electrode material may include calendering or pressing the electrode material to form a sheet-shaped product and manufacturing the electrode film by slitting a periphery portion of the sheet-shaped product.

The electrode material may be made of only the recycling material.

The electrode material may be made of the recycling material and the new material.

The electrode film may have a thickness in a range of 50 to 800 μm and a density in a range of 10 to 60 mg/cm2.

By the method of the present disclosure, a dry electrode film having the same quality as a dry electrode film made from a fresh raw material by introducing an additional treatment process of processing waste electrodes generated during fabrication of dry electrode films.

In addition, by the dry electrode film manufacturing method of the present disclosure, it is possible to effectively recycle the discarded dry electrode films generated during the fabrication of dry electrode films, thereby reducing the raw material cost of electrode materials, such as an electrode active material, a binder, and a conductive material.

As discussed, the method and system suitably include use of a controller or processer.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 is a flowchart showing a method for recycling a dry electrode film according to the present disclosure;

FIG. 2 is a schematic diagram of the state change of new raw materials (fresh raw materials) and recycled materials (recovered waste materials) by process;

FIG. 3A shows a state of a new raw material (fresh raw materials) in the form of a powder in which an active material, a binder, and a conductive material are mixed;

FIG. 3B shows a state of a recycled material (recovered waste materials) that satisfies a preset powder flow index;

FIG. 3C shows a state of a recycled material (recovered waste materials) that does not satisfy a preset powder flow index;

FIG. 4A is a performance evaluation result of an electrode manufactured using a new raw material; and

FIG. 4B is a performance evaluation result of an electrode manufactured using a recycled material (recovered waste materials).

### DESCRIPTION OF THE PREFERRED EMBODIMENTS

The above objectives, other objectives, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

Like reference numerals have been used for like elements in describing each figure. In the accompanying drawings, the dimensions of the structures are enlarged more than the actual size for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In this specification, the terms “include” or “have” should be understood to designate that one or more of the described features, numbers, steps, operations, components, or a combination thereof exist, and the possibility of addition of one or more other features or numbers, operations, components, or combinations thereof should not be excluded in advance. Also, when a part of a layer, film, region, plate, etc., is said to be “on” another part, this includes not only the case where it is “on” another part but also the case where another part is in the middle. Conversely, when a part of a layer, film, region, plate, etc., is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Since they are approximations reflecting various uncertainties in the measurement, it should be understood as being modified by the term “about” in all cases. In addition, when a numerical range is disclosed in this disclosure, this range is continuous and includes all values from the minimum to the maximum value containing the maximum value of this range unless otherwise indicated. Furthermore, when such a range refers to an integer, all integers including the minimum value to the maximum value containing the maximum value, are included unless otherwise indicated.

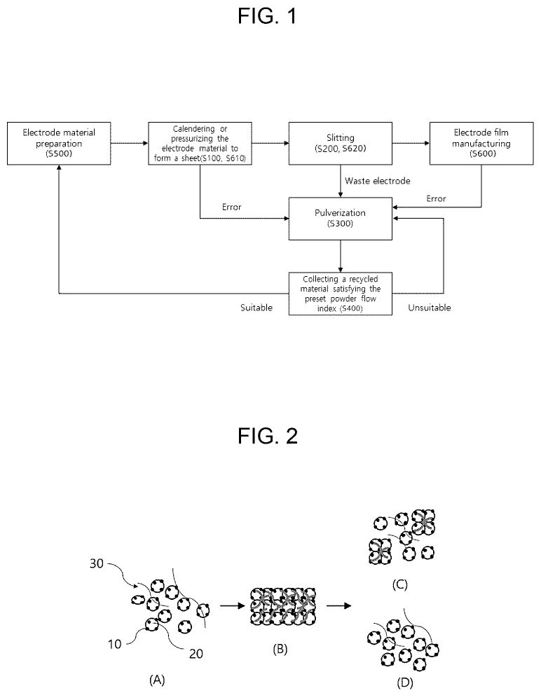

The present disclosure relates to a method for recycling a dry electrode film. Hereinafter, the present disclosure will be described in more detail with reference to the accompanying drawings. FIG. 1 is a flowchart showing a method for recycling a dry electrode film according to the present disclosure.

Referring to FIG. 1, the method for recycling the dry electrode film according to the present disclosure comprising: obtaining waste materials to be recycled by crushing a waste electrode S300; collecting waste materials to be recycled that satisfy a preset powder flow index among the recycled waste materials above S400; preparing an electrode material including the recycled material S500; and manufacturing an electrode film using the electrode material S600.

More specifically, the method for recycling the dry electrode film according to the present disclosure may further comprising: calendering or pressing a new raw material to form a sheet S100; and generating a slitted selvage portion of the electrode film and a waste electrode by slitting the edge of the sheeted product S200, which is performed before the step of pulverizing the waste electrode to obtain waste materials to be recycled S300.

Hereinafter, each step of the method for recycling the dry electrode film according to the present disclosure will be described in detail as follows.

First, in step S100, the new raw material may be calendered or pressed to form a sheet.

The new raw material may be prepared as a free-standing dry electrode film under high temperature and high pressure.

In step S100, a roll-to-roll type film-forming equipment capable of manufacturing a sheet-formed film by injecting a predetermined amount of powder-type new raw material into a feeding facility may be used.

Prior to the description in the present disclosure, “new material” used in the present disclosure refers to a new raw material that is not reused. The “waste materials to be recycled” used in the present disclosure is processed from the “new material”. In the present disclosure, the “waste materials to be recycled” specifically refers to a material that can be recycled after the pulverization process of waste materials due to residues generated in the slitting process or appearance defects (tear and damage) generated in the calendering or pressurizing process.

The new raw material may include an electrode active material, a conductive material, and a binder.

The content and material of the electrode active material, the conductive material, and the binder are not limited, and all materials available in the art may be used.

The binder may be a fibril type binder. Specifically, the binder may be any one selected from those including polytetrafluoroethylene (PTFE), which are essentially made of polytetrafluoroethylene (PTFE), or that polytetrafluoroethylene (PTFE) is not necessarily used.

The new raw material may be a powder mixture in which an electrode active material, a binder, and a conductive material are mixed without a liquid medium such as a solvent or a dispersion medium.

In step S100, the powder mixture may be passed through a pressing roll to make a sheeted product. In this case, the sheeted product may have a thickness in a range of 50 to 800 μm and a density in a range of 10 to 60 mg/cm².

Subsequently, in step S200, the sheeted product is slitted to generate a slitted selvage portion of the electrode film and a waste electrode.

The slitting may be to cut the edge of the sheeted product in order to match a product defect or a desired product width. In this case, a slitted selvage portion of the dry electrode film is generated as a residue during the slitting process, and in the present disclosure, it is referred to as a “waste electrode”.

Subsequently, in step S300, the waste electrode is crushed to obtain a waste material.

The pulverization of the waste electrode may be performed by using at least one selected from the group consisting of a roll mill, a ball mill, a jet mill, a planetary mill, and an attrition mill, but is not limited thereto.

In this case, the pulverization conditions may be performed within 40 minutes at speed in a range of 1,000 to 6,000 rpm, and more specifically, may be performed for 10 to 40 minutes at speed in a range of 1,000 to 6,000 rpm.

In this case, the waste material in powder form obtained through the pulverization process may be pulverized to appropriate particle size.

The waste material may include an electrode active material, a conductive material, and a binder. The binder may be a fibril type binder.

In step S300, according to the present disclosure, the structure of the fibrillated binder in the electrode film may be refined through a pulverization process.

FIG. 2 is a schematic diagram of the state change of new raw materials (fresh raw materials) and recycled materials (recovered waste materials) by the process.

Specifically, referring to FIG. 2, the new raw material, including the electrode active material 10, the conductive material 20, and the binder 30 may be shaped into (A) through a mixing process.

As shown in (A), the binder 30 may have a shape such as a thread skein through which fibrillation proceeds during the mixing process.

The new raw material (A) may be changed into shape (B) through a calendering or pressing process.

As shown in (B), through the roll pressing process, the new raw material A may be formed into a film due to a dense structural binding force between the fibrillated binder 30 and the particles.

In order to recycle the dry electrode film (B) in the film form, a process of crushing the structural bonding force may be required. In particular, the pulverization process of the fibrillated binder 30, which plays an important role in bonding, is required.

Therefore, when the recyclable waste material is changed into (D) form through the pulverization process, it is possible to recycle and manufacture a dry electrode film.

On the other hand, when a simple mixing process is performed without a pulverization process, the waste material exists in the form (C) in which the dense structural bonding force between the fibrillated binder 30 and the particles may not be released, thereby being difficult to prepare the dry electrode film.

Then, in step S400, the powder flow index of the waste material may be measured.

The powder flow index may be a measurement of vertical stress and shear stress by applying a constant external force to the powder. This cohesive strength can measure the physical properties (fluidity) of the powder.

The powder flow index may be measured under the condition that the external force is 0 to 15 kPa based on the analysis method of ASTM D6128. The external force may be expressed as flow index stress.

The analysis method of ASTM D6128 may be a method of measuring the cohesive strength of the powder with fluidity powder and stored powder and may be an experimental method used to determine the flow ability of powders to solve flow disturbances in hopper design by measuring internal friction between the powders, the bulk density, and the friction with various external walls.

The analysis method of ASTM D6128 may apply an external force (shear stress and normal stress) to a predetermined amount of powder sample and measure the internal force in a steady state flow.

The measured data show the distribution of forces with different forces depending on the friction and cohesion between the particles and indicate the flow curve that can index the flow function. Therefore, flow function test is capable of quantifying and counting the flow characteristics of the powders by representing them as an index (flow index). At this time, the flow of the powder between the consolidation stress and the high consolidation stress can be understood.

Subsequently, in step S400, after measuring the powder flow index of the waste material, and the measurement value is evaluated whether a preset powder flow index is satisfied.

The preset powder flow index may be is in a range of “A±0.02” when the powder flow index value of the new raw material is measured as “A”.

The numerical value of the powder flow index of the product may be changed according to electrode composition, physical properties, and conditions.

Therefore, when the powder flow index value of the existing electrode product, which is the standard, is measured as “A”, in the case of recycled powder, the recycled powder can be reused if the error range is within “A±0.02”.

When the preset powder flow index is satisfied, the waste material may be determined to be used as a recycled waste material and proceeds to step S500, to be described below.

When the predetermined powder flow index is not satisfied in step S400, the waste material may be collected by pulverizing the waste material again and then measuring the powder flow index of the waste material again.

Therefore, if the standard electrode product's powder flow index value is measured as “A” and the recycled powder is out of the error range within “A±0.02”, the final recycling condition is satisfied through a re-pulverization process.

If recycled waste material is continuously out of the error range within ‘A±0.02’ during the re-pulverization process, the waste material is discarded.

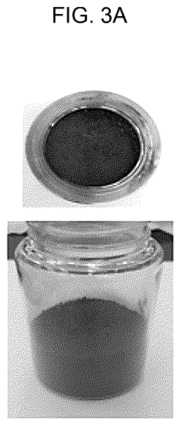

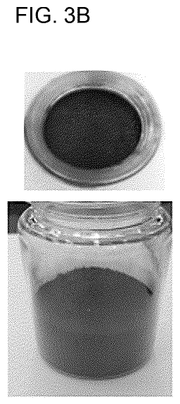

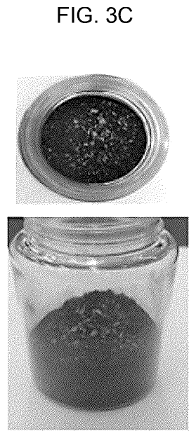

First, FIG. 3A shows a new raw material in the form of a powder in which an active material, a binder, and a conductive material are mixed after mixing is completed.

FIG. 3B shows a state of a recycled material (recovered waste materials) that satisfies a preset powder flow index.

Referring to FIG. 3B, particle characteristics similar to those of the new raw material of FIG. 3A can be confirmed.

FIG. 3C shows a state of a recycled material (recovered waste materials) that does not satisfy a preset powder flow index;

Referring to FIG. 3C, the waste electrode is not well pulverized, and thus it may be confirmed that pulverization is not completely achieved, unlike FIG. 3A and FIG. 3B.

When the state in which the pulverization is not completely performed is reused as the electrode material, defects other than the tearing phenomenon of the sheeted dry electrode film may be generated during the calendering or pressing process.

Next, in step S500, an electrode material including the collected recycled waste material is prepared.

In the embodiment, according to the present disclosure, a dry electrode film, which is a final product, may be manufactured using only recycled waste materials as the electrode material.

In another embodiment, according to the present disclosure, the electrode material may be mixed with the recycled waste material and the new raw material to manufacture a dry electrode film as a final product.

In another embodiment of the present disclosure, since the electrode material and the recycled waste material have similar or equal physical properties (powder flow index), the electrode material may be manufactured to have the same quality as a dry electrode film using only a new raw material.

Finally, in step S600, an electrode film is manufactured from the electrode material.

The manufacturing of the electrode film using the electrode material may include step S610 of manufacturing the electrode material into a sheet by calendering or pressing the electrode material and a step S620 of manufacturing the electrode film by slitting the edge of the sheeted product.

First, in step S610, the recycled waste material may be calendered or pressed to form a sheet. The recycled waste material may be manufactured as a free-standing dry electrode film under high temperature and high pressure.

In S610, the same roll-to-roll type film forming apparatus as in step S100, in which a sheeted film may be manufactured by injecting a predetermined amount of the powder-type recycled waste material into a feeding facility, may be used.

In step S610, a sheeted product may be manufactured by passing the recycled waste material through a pressing roll. In this case, the electrode film obtained by recycling the finally manufactured waste electrode may have a thickness of 50 to 800 μm and a density of 10 to 60 mg/cm².

Subsequently, in step S620, the electrode film may be slitted to manufacture the electrode film in which the waste electrode is recycled, and the same process as in step S200 is performed.

Therefore, the present disclosure effectively recycles discarded dry electrode films generated in manufacturing dry electrode films to reduce material costs for electrode materials, such as active materials, binders, conductive materials, etc.

Hereinafter, the present disclosure will be described in more detail with reference to a specific example. The following examples are merely illustrative to help the understanding of the present disclosure, and the scope of the present disclosure is not limited thereto.

### Example

First, in order to check the performance of the electrode manufactured, by the manufacturing method according to the present disclosure, a dry electrode film using only recycled waste material as an electrode material was manufactured as a unit cell, and the lifespan characteristics were evaluated.

Specifically, in order to evaluate the lifespan characteristics, a dry electrode film for a battery was manufactured by laminating the dry electrode film prepared by the manufacturing method, according to the present disclosure, to a current collector, where an aluminum foil was used as a cathode current collector and a copper foil was used as an anode current collector, and a coin cell (R2032)-type unit cell was manufactured using glass fiber (GFF) as a separator.

The lifespan of the coin cell was charged at 0.1 C, 4.25 V cut-off/0.05 C in CC/CV mode, and was evaluated under discharge conditions at 0.33 C, 1.0 C, and 2.0 C.

### Comparative Example

A dry electrode film was manufactured in the same manner as a unit cell in Examples, except that a new raw material was used as an electrode material instead of using only a recycled waste material as an electrode material, and the lifespan characteristics were evaluated.

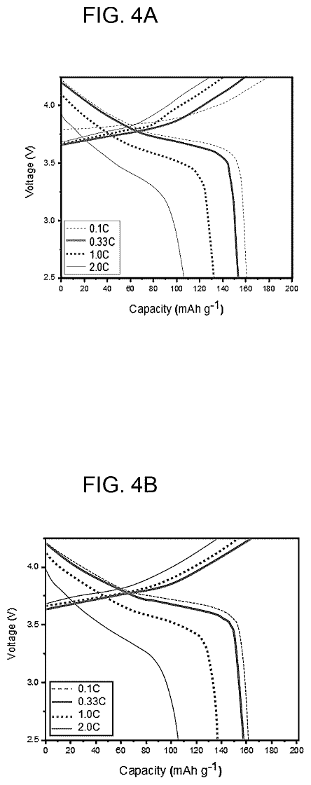

FIG. 4A is a performance evaluation result of an electrode manufactured using only a new raw material as an electrode material. FIG. 4B a performance evaluation result of an electrode manufactured using only a recycled waste material as an electrode material.

Referring to FIGS. 4A and 4B, it can be seen that an electrode manufactured using only a recycled waste material as an electrode material implements the same capacity as a dry electrode manufactured using only a new raw material as an electrode material.

Therefore, in the present disclosure, the method for recycling the dry electrode film may introduce a step of separately treating the waste electrode generated during the manufacturing process of the dry electrode film so that a dry electrode film having the same quality as that of the dry electrode film using a new raw material can be manufactured.

Although the embodiment of the present disclosure has been described above, it will be understood by those skilled in the art that the present disclosure may be implemented in other specific forms without changing the technical spirit or essential features thereof. Therefore, it should be understood that the embodiments described above are illustrative in all respects and not restrictive.

What is claimed is:

1. A method for recycling a dry electrode film, the method comprising:
obtaining waste materials to be recycled by crushing waste electrodes;
collecting a recycling material that satisfy a preset powder flow index among the waste materials;
preparing an electrode material comprising the collected recycling material; and
manufacturing an electrode film using the electrode material.

2. The method of claim 1, wherein the method further comprises:
calendering or pressurizing a new raw material to form a sheet; and
slitting a periphery portion the sheet to produce an electrode film and a waste electrode, which is performed before pulverizing the waste electrode to obtain waste materials.

3. The method of claim 2, wherein the new raw material comprises an electrode active material, a conductive material, and a binder.

4. The method of claim 3, wherein the binder comprises a fibril type binder.

5. The method of claim 3, wherein the binder is selected from those including polytetrafluoroethylene (PTFE), which are essentially made of polytetrafluoroethylene (PTFE), or that polytetrafluoroethylene (PTFE) is not necessarily used.

6. The method of claim 3, wherein the electrode active material, the conductive material, and the binder are mixed without a liquid medium or a dispersion medium.

7. The method of claim 1, wherein the recycled waste material comprises an electrode active material, a conductive material, and a binder.

8. The method of claim 7, wherein the binder comprises a fibril type binder.

9. The method of claim 7, wherein the binder is selected from those including polytetrafluoroethylene (PTFE), which are essentially made of polytetrafluoroethylene (PTFE), or that polytetrafluoroethylene (PTFE) is not necessarily used.

10. The method of claim 7, wherein the electrode active material, the conductive material, and the binder are mixed without a liquid medium or a dispersion medium.

11. The method of claim 1, wherein obtaining of waste materials to be recycled by pulverizing the waste electrode, the pulverization of the waste electrode is performed by using at least one selected from the group consisting of a roll mill, a ball mill, a jet mill, a planetary mill, and an attrition mill.

12. The method of claim 1, wherein in the obtaining of waste materials, the waste electrode is pulverized for a duration equal to or shorter than 40 minutes at a speed in a range of 1,000 to 6,000 rpm.

13. The method of claim 12, in the obtaining of waste materials, wherein the waste electrode is pulverized for 10 to 40 minutes at speed in a range of 1,000 to 6,000 rpm.

14. The method of claim 1, wherein the powder flow index is measured under a condition in which an external force is in a range of 0 to 15 kPa according to the analysis method of ASTM D6128.

15. The method of claim 2, wherein the preset powder flow index is in a range of “A±0.02” when the powder flow index value of the new raw material is measured as “A”.

16. The method of claim 1, wherein when the preset powder flow index is not satisfied after pulverizing the waste material, the recycling material is collected by measuring the powder flow index.

17. The method of claim 1, wherein the manufacturing of an electrode film from the electrode material comprises:
calendering or pressurizing the electrode material to form a sheet-shaped product; and
manufacturing an electrode film by slitting a periphery portion of the sheet-shaped product.

18. The method of claim 1, wherein the electrode material comprises made of only recycling material.

19. The method of claim 2, wherein the electrode material comprises the recycling material and the new raw material.

20. The method of claim 1, wherein the electrode film has a thickness in a range of 50 to 800 μm and a density in a range of 10 to 60 mg/cm².
